(19) United States
(12) Patent Application Publication
(10) Pub. No.: US 2006/0140601 A1
(43) Pub. Date: Jun. 29, 2006

(54) Imaging apparatus

(75) Inventors: Yoshifumi Mitani, Osaka (JP); Hiroshige Mori, Osaka (JP); Atsushi Yamanishi, Tokyo (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/274,227

(22) Filed: Nov. 14, 2005

(30) Foreign Application Priority Data
Dec. 27, 2004 (JP) 2004-375416
Jul. 8, 2005 (JP) 2005-200755

(51) Int. Cl. G03B 17/00

(52) U.S. Cl. 396/55; 396/448

(57) ABSTRACT

There is provided an imaging apparatus having a lens barrier in which a gap does not arise between the lens barrier and a casing when the lens barrier is closed, and yet a driving source exclusively for the lens barrier is not required. The imaging apparatus has casings 1, 2 having a lens opening 5 provided therein, a lens barrel unit 4 that is swingably supported inside the casings 1, 2 and faces out onto a photographic subject from the lens opening 5, swinging means 101, 10b for swinging the lens barrel unit 4 so as to control the attitude of the lens barrel unit 4, and a lens barrier 7 that is movably supported on the casing 1, 2 and can be moved so as to close or open up the lens opening 5. The lens barrel unit 4 has a linking member 11 that drives the lens barrier 7. The linking member 11 is isolated from the lens barrier 7 at least when the swinging means 10a, 10b are changing the attitude of the lens barrel unit 4.

This application is based on applications Nos. 2004-375416 and 2005-200755 filed in Japan, the contents of which is hereby incorporated by reference.

### BACKGROUND OF THE INVENTION

1. Field of the Invention

The present invention relates to an imaging apparatus of a type in which hand shake compensation is carried out by swinging a lens barrel unit.

2. Description of the Related Art

Japanese Patent Application Laid-open No. 7-274056 describes an imaging apparatus such as a digital camera in which hand shake compensation is carried out by swinging the whole of a lens barrel unit housed inside a casing so as to counteract hand shake. Moreover, many small imaging apparatuses are made to be such that an objective lens is covered by a lens barrier so as to protect the objective lens.

To prevent foreign matter from getting inside an imaging apparatus, the lens barrier must be made such that there is no gap between the lens barrier and the casing when the lens barrier is closed. It is possible to drive the lens barrier using a motor that is for driving lenses if the lens barrier is provided on the lens barrel unit, but because the orientation of the lens barrel unit will have to be changed horizontally and vertically for hand shake compensation, it will not be possible to eliminate a gap between the lens barrier and the casing. Moreover, an increase in the mass or moment of inertia of the lens barrel unit leads to a decrease in the responsiveness of the hand shake compensation and an increase in the electrical power consumption.

If the lens barrier is thus provided on the casing, then because the lens barrel unit must be mechanically separated from the casing so that the lens barrel unit can be swung for hand shake compensation, a motor exclusively for driving the lens barrier must be provided as described in Japanese Patent Application Laid-open No. 2001-5050. As a result, there has been the problem that the structure of the imaging apparatus becomes more complex, leading to an increase in the size of the imaging apparatus and an increase in the manufacturing cost.

### SUMMARY OF THE INVENTION

In view of the problems described above, it is an object of the present invention to provide an imaging apparatus having a lens barrier, according to which a gap does not arise between the lens barrier and the casing when the lens barrier is closed, and yet a driving source exclusively for the lens barrier is not required.

To attain the above object, an imaging apparatus according to the present invention comprises: a casing having a lens opening provided therein; a lens barrel unit that is swingably supported inside the casing, and faces out onto a photographic subject from the lens opening; swinging means for swinging the lens barrel unit to control an attitude of the lens barrel unit; and a lens barrier that is movably supported on the casing, and can be moved so as to close or open up the lens opening; wherein the lens barrel unit has a linking member that drives the lens barrier; and the linking member is isolated from the lens barrier at least when the swinging means is changing the attitude of the lens barrel unit.

According to this constitution, a driving source exclusively for opening and closing the lens barrier is not required, and moreover the linking member is isolated from the lens barrier during operation of the swinging means, and hence the swinging of the lens barrel unit is not impeded. Moreover, because the lens barrier is provided on the casing, the lens opening can be closed up with no gap.

Moreover, in the imaging apparatus of the present invention, it may be made to be such that: the lens barrier has a force applied thereto by a force-applying member in an opening direction such as to open up the lens opening; the casing has an opening extreme regulating portion that contacts the lens barrier at an open position in which the lens opening is opened up, thus restricting movement of the lens barrier in the opening direction; and the linking member can push the lens barrier in a closing direction to close up the lens opening, and move back to allow opening up of the lens barrier by the force-applying member, and moreover can move further back after the lens barrier has reached the open position.

According to this constitution, the force-applying member pushes the lens barrier against the linking member such as to cause the lens barrier to follow movement of the linking member, and moreover when the linking member is isolated from the lens barrier, pushes the lens barrier against the opening extreme regulating portion so as to fix the lens barrier in the open position. As a result, the lens barrier can be positioned without clattering around.

Moreover, in the imaging apparatus of the present invention, it may be made to be such that: the casing has a closing extreme regulating portion that contacts the lens barrier at a closed position in which the lens opening is closed up, thus restricting movement of the lens barrier in the closing direction; and the linking member pushes the lens barrier via an elastic member.

According to this constitution, after the lens barrier has reached the closed position, the linking member can push further such as to elastically deform the elastic member. As a result, the position of the linking member when closing up the lens barrier does not have to be set precisely. Because highly precise positioning of the linking member relative to the lens barrier is not required, the imaging apparatus can be provided cheaply. Moreover, if the elastic member is provided on the lens barrier, then the linking member can be made light in weight, and hence there is less load on the swinging means.

Moreover, in the imaging apparatus of the present invention, the linking member may be driven by a driving mechanism that drives a lens in the lens barrel unit.

Moreover, in the imaging apparatus of the present invention, the swinging means may carry out hand shake compensation of controlling the attitude of the lens barrel unit such as to counteract a change in attitude of the casing, with no interference between the swinging means and the lens barrier.

As described above, according to the present invention, the lens barrier is provided on the casing, and hence a gap does not arise when the lens barrier is closed. Moreover, the lens barrier is driven by the linking member of the lens barrel unit, and hence the same driving source can be used for the lens barrel unit and the lens barrier. Furthermore, the linking member can be isolated from the lens barrier, and hence the lens barrel unit and the casing can be mechanically detached from one another, and thus the whole of the lens barrel unit can be swung to carry out hand shake compensation. A small imaging apparatus having a hand shake compensating function, according to which the casing can be closed up with no gap arising between the casing and the lens barrier and yet without providing a driving apparatus exclusively for the lens barrier, can thus be provided cheaply.

### BRIEF DESCRIPTION OF THE DRAWINGS

Further objects and advantages of the present invention will become clear from the following description taken in conjunction with the preferred embodiments thereof with reference to the accompanying drawings, in which:

FIG. 1 is an exploded perspective view of a digital camera according to an embodiment of the present invention;

FIG. 2 is a perspective view of a lens barrel unit shown in FIG. 1;

FIG. 3 is an enlarged perspective view from the rear of a lens barrier mounting structure shown in FIG. 1;

FIG. 4 is a perspective view of the lens barrel unit shown in FIG. 1 with parts removed therefrom;

FIG. 5 is an enlarged perspective view from the rear of a driving mechanism when a lens barrier is completely closed;

FIG. 6 is an enlarged perspective view from the rear of the driving mechanism shown in FIG. 5 when a lens position is at a wide extreme;

FIG. 7 is an enlarged perspective view from the rear of the driving mechanism shown in FIG. 5 when the lens position is in the middle of zooming;

FIG. 8 is an enlarged perspective view from the rear of the driving mechanism shown in FIG. 5 when the lens position is at a telephoto extreme;

FIG. 9 is a rear view showing the relationship between the lens barrier and a linking member during taking of a picture;

FIG. 10 is a rear view showing the relationship between the lens barrier and the linking member when the lens barrier is partially closed;

FIG. 11 is a rear view showing the relationship between the lens barrier and the linking member when the lens barrier is completely closed; and,

FIG. 12 is a rear view showing the relationship between the lens barrier and the linking member when a power source is shut off.

### DESCRIPTION OF THE PREFERRED EMBODIMENTS

Following is a description of an embodiment of the present invention with reference to the drawings.

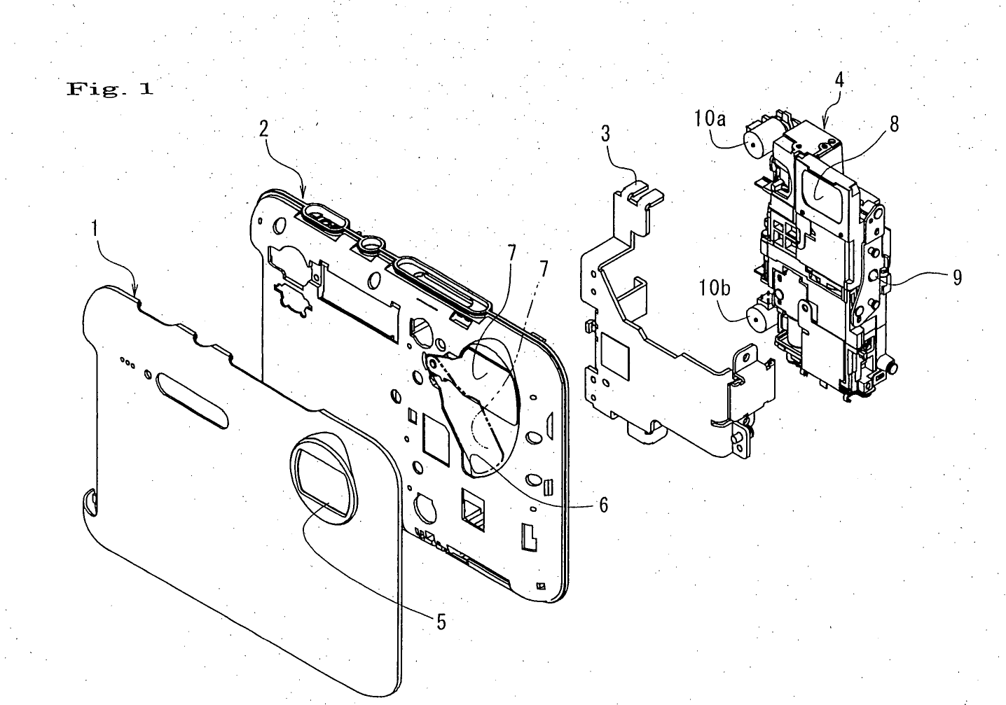

FIG. 1 shows a front portion of a digital camera, which is an embodiment of the present invention, in an exploded state. The digital camera of the present embodiment comprises a front casing 1 that forms an exterior of the front of the digital camera, an internal casing 2 that supports various constituent elements housed inside the front casing 1, and a rear casing and a rear cover, not shown. In the digital camera, a lens barrel unit 4 is mounted on a supporting frame 3 that is fixed inside the internal casing 2. The digital camera also has other constituent elements, not shown, such as a display, a memory, and a battery. A lens opening 5 is provided in the front casing 1. The lens opening 5 can be opened, or closed up without a gap, using a lens barrier 7 that is supported so as to be turnable on a barrier housing portion 6 of the internal casing 2. The lens barrel unit 4 has therein an objective lens 8 that faces out onto a photographic subject via the lens opening 5. A pivoting ball 9 provided on a side of the lens barrel unit 4 is supported on the supporting frame 3, and the top and bottom of the lens barrel unit 4 on the opposite side to the pivoting ball 9 are supported respectively by swinging motors (swinging means) 10a and 10b.

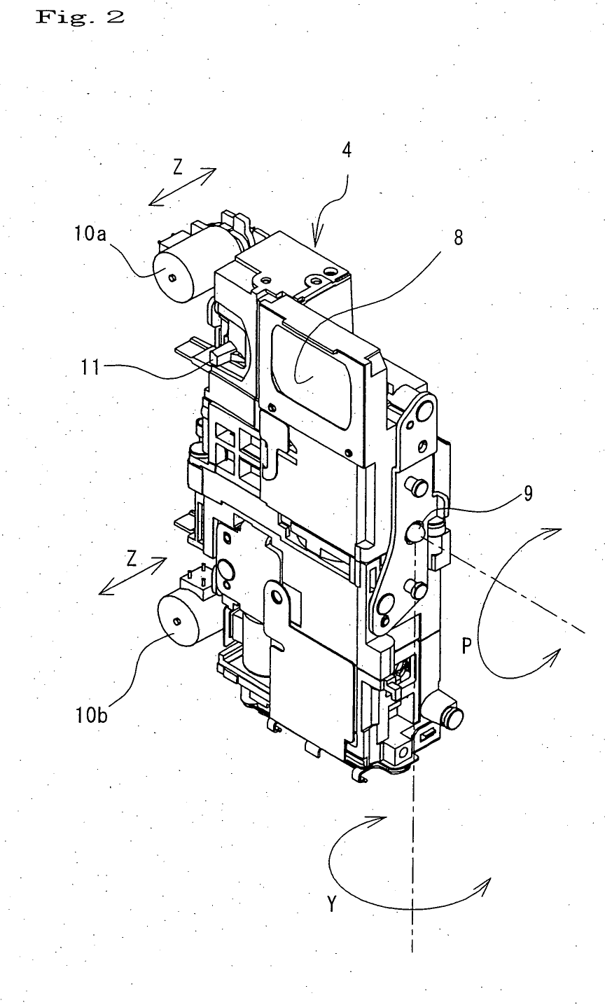

As shown in detail in FIG. 2, the swinging motors 10a and 10b are able to move respectively the top and bottom of one side of the lens barrel unit 4 forward/backward in the Z-direction. If the two swinging motors 10a and 10b move the top and bottom of the lens barrel unit 4 in the same direction, then the lens barrel unit 4 turns left/right in a yawing direction (Y-direction) around a vertical axis that passes through the pivoting ball 9. Moreover, if the swinging motors 10a and 10b move the top and bottom of the lens barrel unit 4 in opposite directions, then the lens barrel unit 4 turns up/down in a pitching direction (P-direction) around a horizontal axis that passes through the pivoting ball 9 and is orthogonal to the direction of the photographic subject.

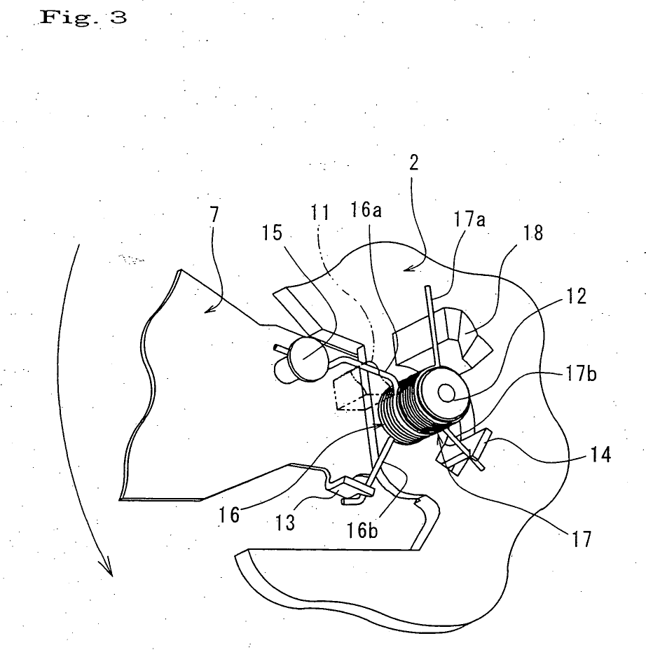

FIG. 3 shows, from the rear of the internal casing 2, a structure for mounting the lens barrier 7. A pin, not shown, is inserted from the front side into a bearing 12 that is provided projecting out from the rear face of the internal casing 2, whereby the lens barrier 7 can turn around the bearing 12. In the vicinity of the pin on which the lens barrier 7 pivots, there are provided a closing projection 13 and a force-applying projection 14 that are each formed by bending an extension of an edge portion of the lens barrier 7 so as to project out to the rear of the internal casing 2. Furthermore, an arm pin 15 is fixed by riveting to the lens barrier 7. A buffer spring (elastic member) 16 and an opening force-applying spring (force-applying member) 17 are installed on a periphery of the bearing 12. The buffer spring 16 has thereon a communicating arm 16a and an opening arm 16b, and applies a force so as to cause the arms 16a and 16b to approach one another. The communicating arm 16a contacts the arm pin 15, and the opening arm 16b contacts the closing projection 13 of the lens barrier 7, thus the buffer spring 16 sandwiches the arm pin 15 and the closing projection 13 from either side. The opening force-applying spring 17 has thereon a fixed arm 17a and a force-applying arm 17b, and applies a force so as to cause the arms 17a and 17b to approach one another. The fixed arm 17a is fixed in contact with a fixed projection 18 that is provided projecting out from the rear face of the internal casing 2, and the force-applying arm 17b contacts the force-applying projection 14 of the lens barrier 7; thus the opening force-applying spring 17 applies a force in a direction such that the force-applying arm 17b pushes the force-applying projection 14 upward so as to open up the lens barrier 7 downward, as shown by the arrow in FIG. 3.

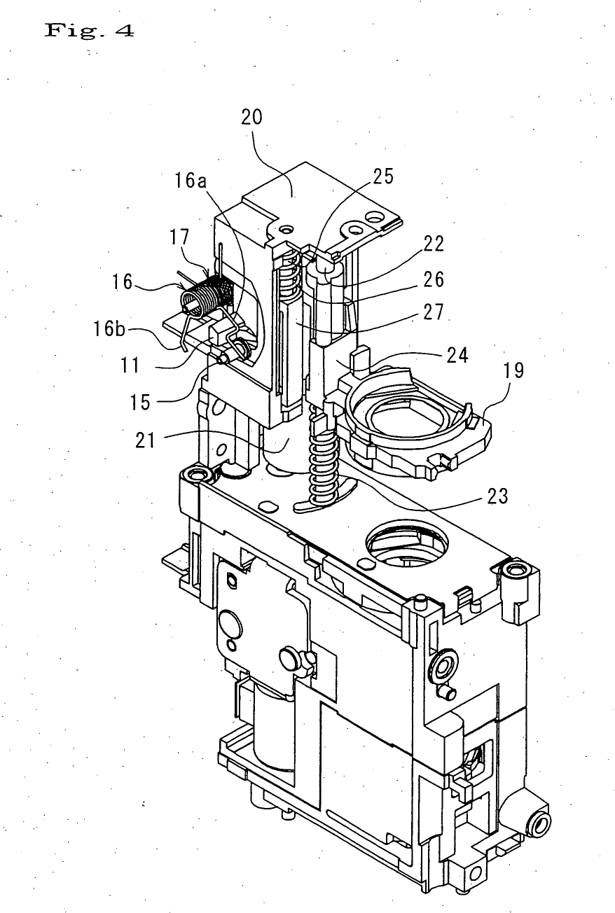

FIG. 4 shows the lens barrel unit 4 with the objective lens 8 and some other parts removed therefrom. The lens barrel unit 4 has a lens frame 19 that holds a magnification lens and a linking member 11, both of which are driven by a driving motor 21 that is a driving source provided on a frame 20. The lens frame 19 is formed integrally with a first moving member 24, which is slidably supported on a vertical first suspending shaft 22 fixed to the frame 20, and has an upward force applied thereto by a first force-applying member 23. The linking member 11 is formed integrally with a second moving member 27, which is slidably supported on a second suspending shaft 25 fixed to the frame 20, and has a downward force applied thereto by a second force-applying member 26. Moreover, the linking member 11 contacts the communicating arm 16a of the buffer spring 16 from below.

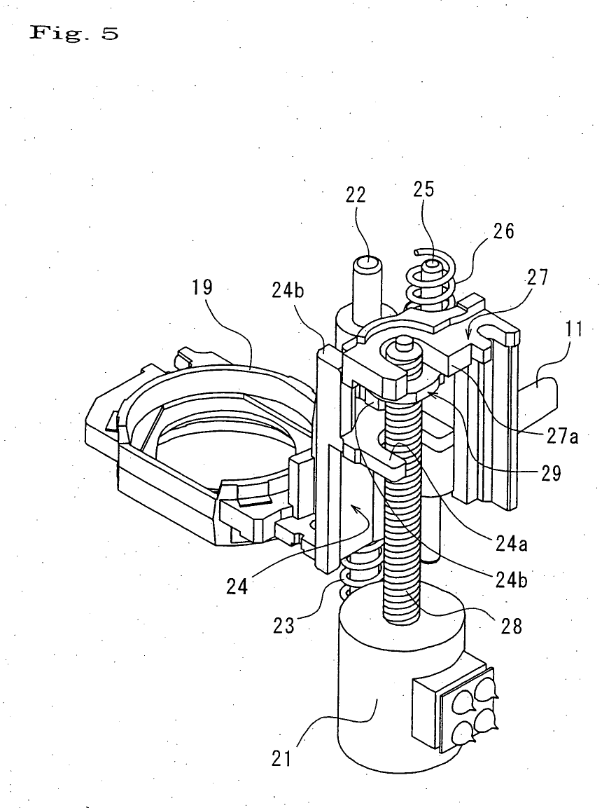

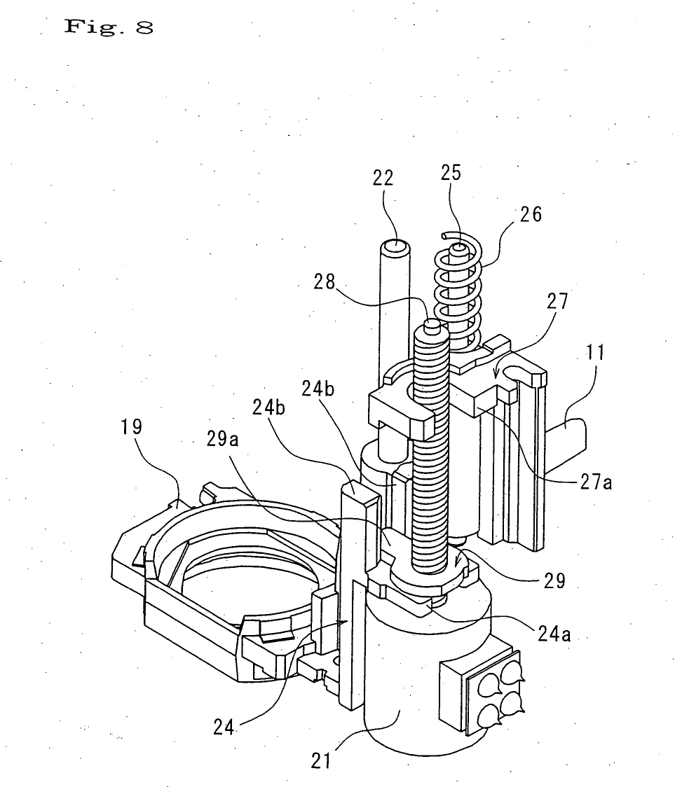

FIGS. 5 to 7 show the first moving member 24, the second moving member 27 and the driving motor 21 viewed from the rear. An output shaft of the driving motor 21 forms a feed screw 28, and the feed screw 28 engages with an internal screw thread provided on a driving member 29 having a projecting portion 29a (see FIG. 8). The first moving member 24 is provided thereon with a U-shaped first contacting piece 24a that projects out below the driving member 29 so as to surround the feed screw 28, and guiding portions 24b that sandwich the projecting portion 29a of the driving member 29 therebetween and thus guide the projecting portion 29a such that the driving member 29 does not rotate around the feed screw 28. The second moving member 27 is provided thereon with a U-shaped second contacting piece 27a that projects out above the driving member 29 so as to surround the feed screw 28.

A description will now be given of the driving mechanism for the lens frame 19 and the lens barrier 7 by the driving motor 21 for the digital camera of the present embodiment.

FIG. 5 shows the relationship between the driving member 29, and the lens frame 19 and the second moving member 27 in a state in which the driving motor 21 has closed up the lens barrier 7 upon a power source of the digital camera being turned off. The driving motor 21 has moved the driving member 29 approximately as far as the tip of the feed screw 28, and hence the driving member 29 is in contact with a lower face of the second contacting piece 27a of the second moving member 27, thus pushing the second moving member 27 upward along the second suspending shaft 25 against the force applied by the second force-applying member 26. On the other hand, the lens frame 19 has been pushed upward by the first force-applying member 23 along the first suspending shaft 22, whereby an upper end of the guiding portions 24b contacts the frame 20 (see FIG. 4) so that the movement is restricted, and hence the lens frame 19 stops in the position shown in FIG. 5 and is thus isolated from the driving member 29.

Upon the power source of the digital camera being turned on, the driving motor 21 rotates the feed screw 28 so as to move the driving member 29 downward. Then, the second moving member 27 is pushed against by the second force-applying member 26 so as to keep the second contacting piece 27a in close contact with the driving member 29, and hence the second moving member 27 descends following the driving member 29.

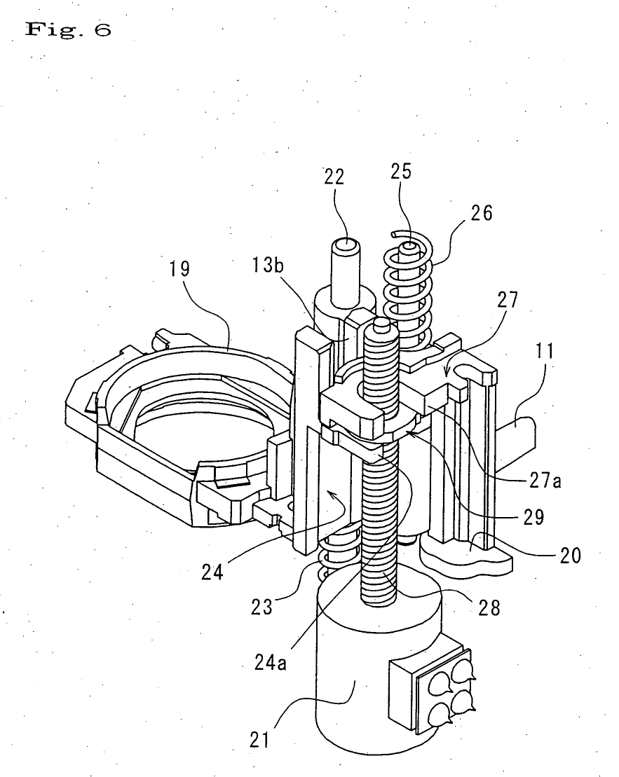

As shown in FIG. 6, upon the driving member 29 descending as far as a prescribed position, a lower end of the second moving member 27 contacts the frame 20, whereby movement of the second moving member 27 is restricted, and hence it becomes that the second moving member 27 can no longer follow the driving member 29 downward, and thus the driving member 29 is isolated from the second contacting piece 27a of the second moving member 27. Upon the driving member 29 descending slightly further, the driving member 29 contacts an upper face of the first contacting piece 24a of the first moving member 24. At this time, the lens frame 19 holds the lens at a wide extreme (the position in which the maximum angle of view is obtained).

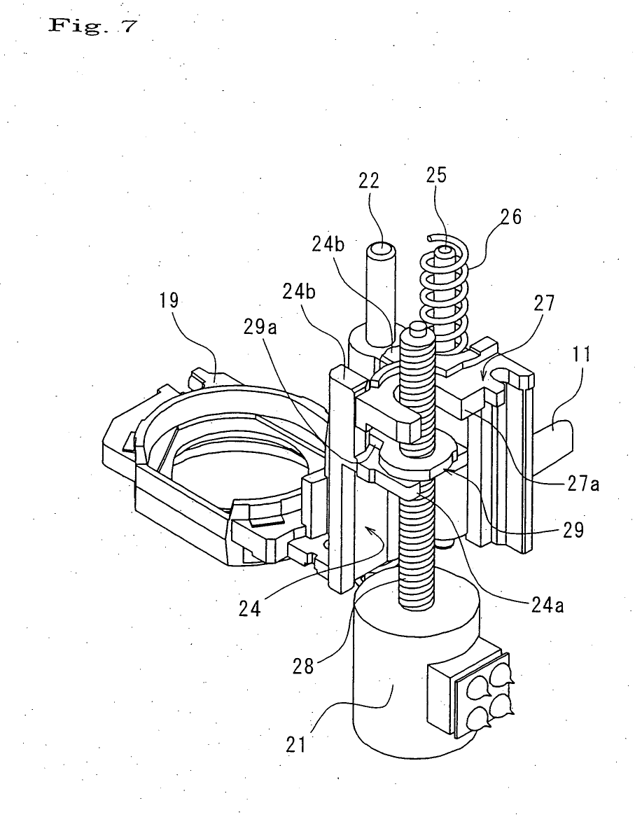

Upon carrying out a zooming operation of the digital camera, as shown in FIG. 7, the driving motor 21 causes the driving member 29 to descend further, thus pushing the first moving member 24 down along the first suspending shaft 22 against the force applied by the first force-applying member 23. By controlling the angle of rotation of the driving motor 21, the driving member 29 can be positioned precisely, and hence through the first contacting piece 24a being pushed against a lower face of the driving member 29 by the first force-applying member 23, the position of the lens frame 19 can be set precisely. In this way, optical zooming in which the position of the lens is adjusted so as to change the size of the formed image is carried out. FIG. 8 shows a state in which the lens frame 19 has been caused to descend as far as a telephoto extreme (the position in which the minimum angle of view is obtained).

Upon turning the power source of the digital camera off, the driving motor 21 moves the driving member 29 upward, thus returning the lens frame 19 and the linking member 11 to the state shown in FIG. 5.

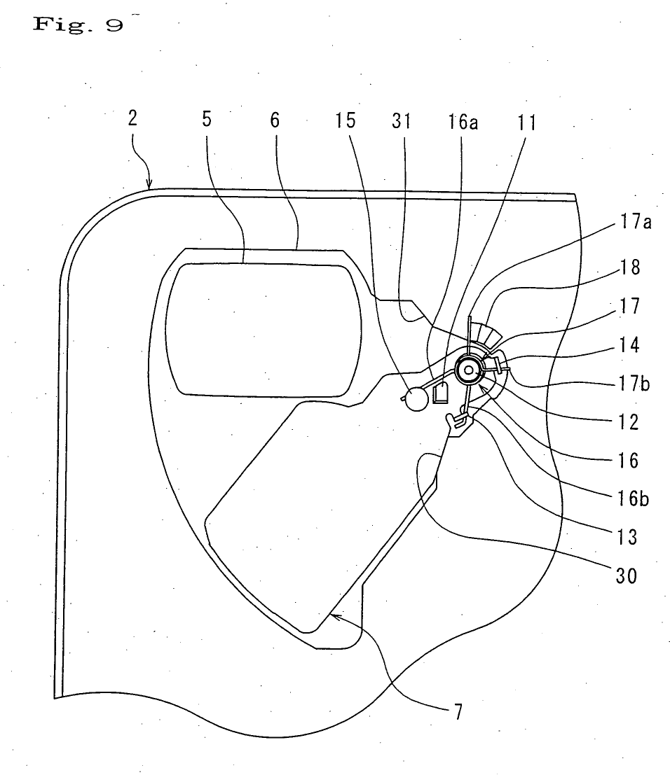

FIG. 9 shows the relationship between the linking member 11 and the lens barrier 7 when the driving member 29 is in contact with the first contacting piece 24a of the first moving member 24 (FIGS. 6 to 7). The lens barrier 7 is turned around the bearing 12 by the opening force-applying spring 17 such as to open up the lens opening 5, and the lens barrier 7 contacts an opening extreme regulating portion 30 of the barrier housing portion 6, whereby the angle of the lens barrier 7 is set. At this time, the linking member 11 is slightly separated away from the communicating arm 16a of the buffer spring 16, and is thus isolated from the lens barrier 7.

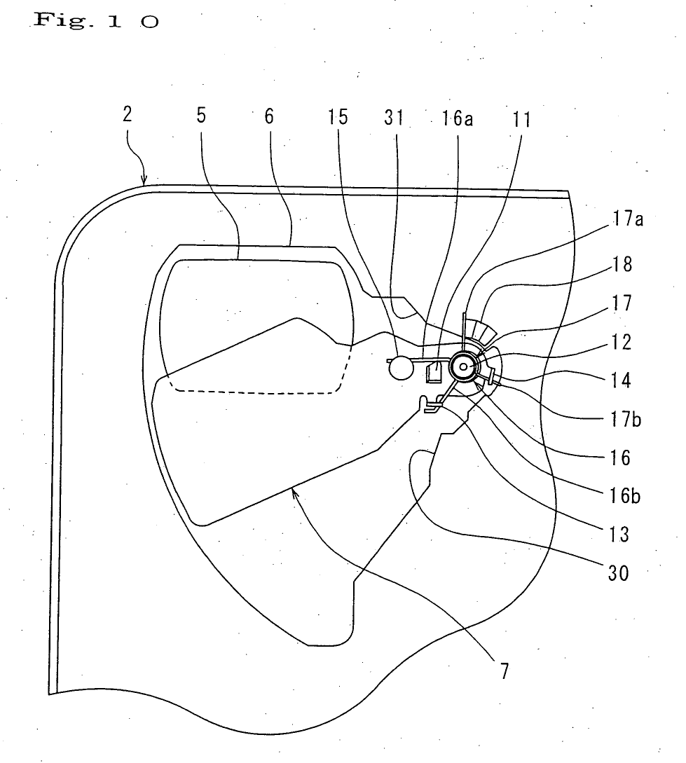

Upon the driving member 29 rising and hence the linking member 11 rising more than in FIG. 6, as shown in FIG. 10, the linking member 11 pushes the communicating arm 16a and thus turns the buffer spring 16 around the bearing 12. The opening arm 16b thus pushes the closing projection 13 of the lens barrier 7 up, hence turning the lens barrier 7 against the force applied by the opening force-applying spring 17, i.e. in a direction such as to close up the lens opening 5.

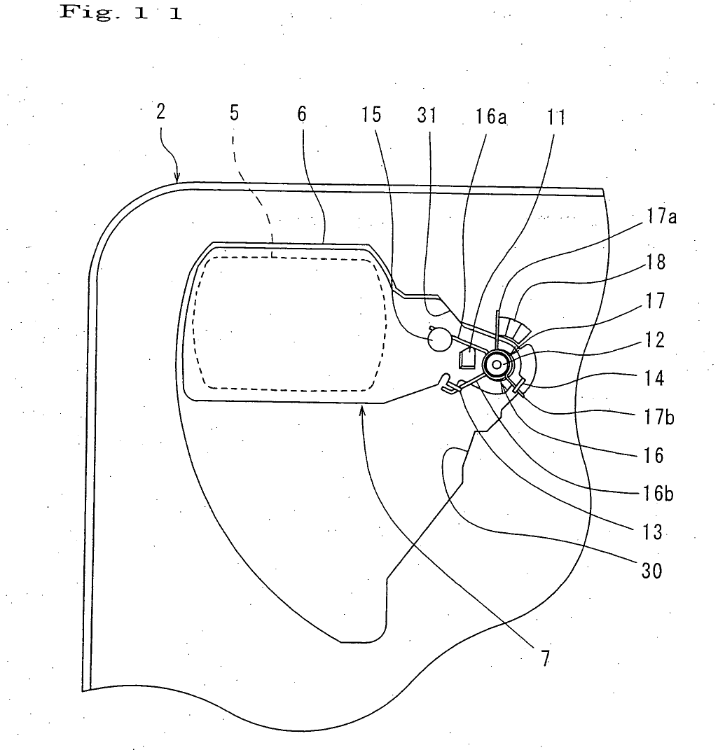

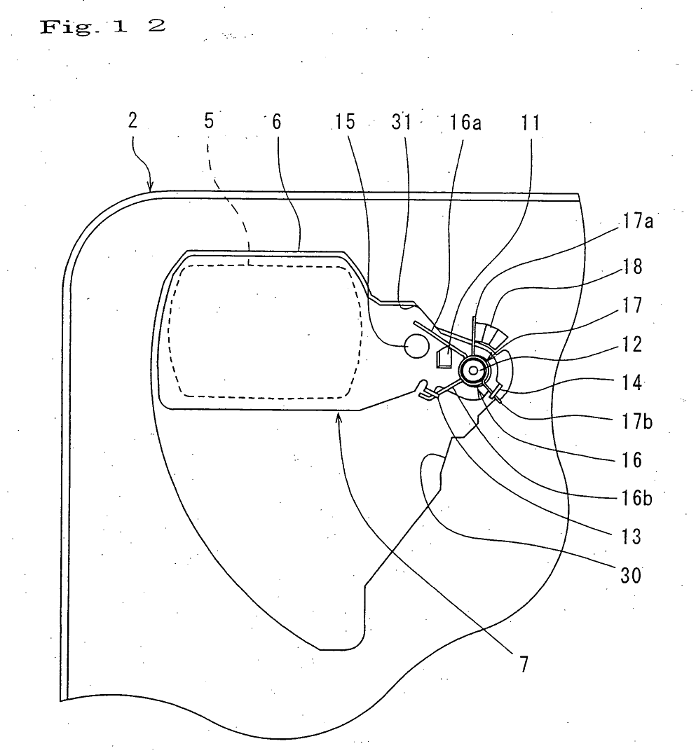

As shown in FIG. 11, upon the lens barrier 7 turning as far as a position in which the lens opening 5 is completely closed up, the lens barrier 7 contacts a closing extreme regulating portion 31 provided on the barrier housing portion 6. Upon the linking member 11 rising further, as shown in FIG. 12, because the lens barrier 7 cannot turn any further, the linking member 11 causes the communicating arm 16a of the buffer spring 16 to undergo elastic deformation such as to be isolated from the arm pin 15.

Because of the presence of the buffer spring 16, the upper extreme of the range of movement of the linking member 11 does not have to correspond precisely to the closed position of the lens barrier 7, but rather the linking member 11 should push ahead (rise) so as to try to turn the lens barrier 7 slightly excessively.

Moreover, upon the linking member 11 moving back (descending), the opening force-applying spring 17 turns the lens barrier 7 such as to push the communicating arm 16a of the buffer spring 16 against the linking member 11, thus causing the lens barrier 7 to follow the movement of the linking member 11.

Once the lens barrier 7 has opened up the lens opening 5 and contacted the opening extreme regulating portion 30, the linking member 11 moves further downward, and hence as shown in FIG. 9, separates away from communicating arm 16a and is thus isolated from the lens barrier 7.

That is, according to the digital camera of the present embodiment, even though the lens frame 19 and the lens barrier 7 can be driven by the same driving motor 21, in an image-taking state (FIGS. 6 to 8), the linking member 11 is isolated from the buffer spring 16, and hence is mechanically detached from the lens barrier 7. The lens barrier 7 and the buffer spring 16 thus do not inhibit the swinging of the lens barrel unit 4 for hand shake compensation by the swinging motors 10a and 10b.

The lens barrier 7 is not limited to being supported on the internal casing 2, but rather may instead be supported on a constituent element substantially fixed to the front casing 1 or the internal casing 2, for example the supporting frame 3 which is fixed inside the internal casing 2.

Although the present invention has been fully described by way of the examples with reference to the accompanying drawing, it is to be noted that various changes and modifications will be apparent to those skilled in the art. Therefore, unless such changes and modifications otherwise depart from the spirit and scope of the present invention, they should be construed as being included therein.

What is claimed is:

1. An imaging apparatus comprising:
a casing having a lens opening provided therein;
a lens barrel unit that is swingably supported inside said casing, and faces out onto a photographic subject from said lens opening;
swinging means for swinging said lens barrel unit to control an attitude of said lens barrel unit; and
a lens barrier that is movably supported on said casing, and can be moved so as to close or open up said lens opening, wherein
said lens barrel unit has a linking member that drives said lens barrier, and
said linking member is isolated from said lens barrier at least when said swinging means is changing the attitude of said lens barrel unit.

2. The imaging apparatus according to claim 1, wherein,
said lens barrier has a force applied thereto by a force-applying member in an opening direction such as to open up said lens opening,
said casing has an opening extreme regulating portion that contacts said lens barrier at an open position in which said lens opening is opened up, thus restricting movement of said lens barrier in said opening direction, and
said linking member can push said lens barrier in a closing direction to close up said lens opening, and move back to allow opening up of said lens barrier by said force-applying member, and moreover can move further back after said lens barrier has reached said open position.

3. The imaging apparatus according to claim 2, wherein,
said casing has a closing extreme regulating portion that contacts said lens barrier at a closed position in which said lens opening is closed up, thus restricting movement of said lens barrier in said closing direction, and
said linking member pushes said lens barrier via an elastic member.

4. The imaging apparatus according to claim 3, wherein said elastic member is provided on said lens barrier.

5. The imaging apparatus according to claim 1, wherein said linking member is driven by a driving mechanism that drives a lens in said lens barrel unit.

6. The imaging apparatus according to claim 2, wherein said linking member is driven by a driving mechanism that drives a lens in said lens barrel unit.

7. The imaging apparatus according to claim 1, wherein said swinging means carries out hand shake compensation of controlling the attitude of said lens barrel unit so as to counteract a change in attitude of said casing.

8. The imaging apparatus according to claim 2, wherein said swinging means carries out hand shake compensation of controlling the attitude of said lens barrel unit so as to counteract a change in attitude of said casing.
